(19) United States
(12) Patent Application Publication
(10) Pub. No.: US 2026/0173170 A1
(43) Pub. Date: Jun. 18, 2026

(54) PRINTING APPARATUS, PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Junpei KOIZUMI, Matsumoto (JP)

(21) Appl. No.: 19/419,201

(22) Filed: Dec. 15, 2025

(30) Foreign Application Priority Data
Dec. 16, 2024 (JP) 2024-219774

(51) Int. Cl. H04W 76/10; B41J 2/175; B41J 29/393; G06F 3/12; H04W 4/80

(52) U.S. Cl. CPC H04W 76/10; B41J 2/17566; B41J 29/393; G06F 3/1236; G06F 3/1292; H04W 4/80

(57) ABSTRACT

A printing apparatus according to the present disclosure includes: a printing section configured to perform printing on a medium; a first wireless communication section configured to perform communication in accordance with a first wireless communication standard; a second wireless communication section configured to perform communication in accordance with a second wireless communication standard; a state determination section configured to determine whether printing is executable by the printing section; and a wireless setting section configured to cause the printing section to print a code image including predetermined information in a case where it is determined that the printing is executable by the printing section and cause the second wireless communication section to transmit the predetermined information in a case where it is determined that the printing is not executable by the printing section.

The present application is based on, and claims priority from JP Application Serial Number 2024-219774, filed Dec. 16, 2024, the disclosure of which is hereby incorporated by reference herein in its entirety.

### BACKGROUND

### 1. Technical Field

The present disclosure relates to a printing apparatus, a processing method, and a non-transitory computer-readable storage medium storing a program.

### 2. Related Art

The function called Wi-Fi Easy Connect (registered trademark) designed by Wi-Fi Alliance is known. This function is a technique in which an apparatus called a configurator provides access point information to an apparatus called an enrollee in accordance with the Device Provisioning Protocol (DPP). As a result, the enrollee that has acquired the access point information can wirelessly connect to an access point.

In this regard, JP-A-2019-205021 discloses utilization of the DPP to cause a printing apparatus to wirelessly connect to an access point.

According to the technique disclosed in JP-A-2019-205021, the printing apparatus prints a QR code (registered trademark) in bootstrapping performed as the first phase of the DPP. Although QR codes are familiar to general users, and it is thus preferable to perform the bootstrapping by printing a QR code from the viewpoint of user friendliness, the QR code cannot be output in a case where the printing apparatus is in a non-printable state. Therefore, there is a problem that the printing apparatus cannot be connected to the access point for wireless communication in such a case.

### SUMMARY

A printing apparatus according to the present disclosure includes: a printing section configured to perform printing on a medium; a first wireless communication section configured to perform communication in accordance with a first wireless communication standard; a second wireless communication section configured to perform communication in accordance with a second wireless communication standard; a state determination section configured to determine whether printing is executable by the printing section; and a wireless setting section configured to cause the printing section to print a code image including predetermined information in a case where it is determined that the printing is executable by the printing section and cause the second wireless communication section to transmit the predetermined information in a case where it is determined that the printing is not executable by the printing section, in which the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

A processing method according to the present disclosure causes a printing apparatus that includes a printing section configured to perform printing on a medium, a first wireless communication section configured to perform communication in accordance with a first wireless communication standard, and a second wireless communication section configured to perform communication in accordance with a second wireless communication standard to: determine whether printing is executable by the printing section; cause the printing section to print a code image including predetermined information in a case where it is determined that the printing is executable by the printing section; and cause the second wireless communication section to transmit the predetermined information in a case where it is determined that the printing is not executable by the printing section, in which the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

A non-transitory computer-readable storage medium storing a program according to the present disclosure causes a computer of a printing apparatus that includes a printing section configured to perform printing on a medium, a first wireless communication section configured to perform communication in accordance with a first wireless communication standard, and a second wireless communication section configured to perform communication in accordance with a second wireless communication standard to: determine whether printing is executable by the printing section; cause the printing section to print a code image including predetermined information in a case where it is determined that the printing is executable by the printing section; and cause the second wireless communication section to transmit the predetermined information in a case where it is determined that the printing is not executable by the printing section, in which the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

### BRIEF DESCRIPTION OF THE DRAWINGS

FIG. 1 is a block diagram for explaining a configuration example of a system including a printing apparatus and a terminal apparatus.

FIG. 2 is a block diagram illustrating an example of a configuration of the printing apparatus.

FIG. 3 is a diagram illustrating an example of printing performed by a printing section.

FIG. 4 is a block diagram illustrating an example of a configuration of the terminal apparatus.

FIG. 5 is a flowchart illustrating an example of a flow of processing in a bootstrapping phase in the printing apparatus.

FIG. 6 is a sequence chart illustrating an example of a flow of operations by which the printing apparatus establishes wireless connection with an access point.

FIG. 7 is a block diagram illustrating an example of a hardware configuration of a computer included in the printing apparatus or the terminal apparatus.

### DESCRIPTION OF EMBODIMENTS

Hereinafter, embodiments and the like will be described with reference to the drawings. For the sake of clarity of explanation, the following description and drawings are appropriately omitted and simplified. In the drawings, the same elements are denoted by the same reference signs, and redundant description thereof will be omitted as appropriate. In addition, not all of the features or steps illustrated in any one of the drawings to describe an exemplary embodiment are necessarily essential, and some features or steps may be omitted. Furthermore, the order of the steps described in any of the drawings may be changed as appropriate.

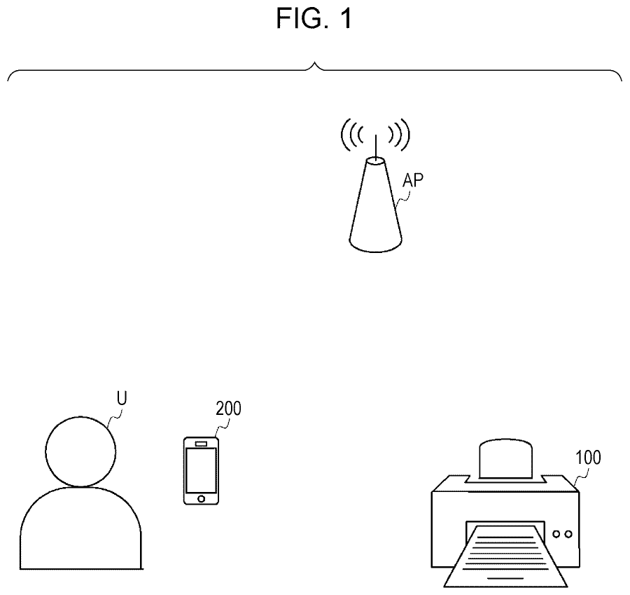

FIG. 1 is a block diagram for explaining a configuration example of a system including a printing apparatus 100 and a terminal apparatus 200 according to an embodiment. In the present embodiment, both the printing apparatus 100 and the terminal apparatus 200 are apparatuses provided with the Wi-Fi Easy Connect function. In the present embodiment, the terminal apparatus 200 is an apparatus that already has access point information. The terminal apparatus 200 may be a terminal that has already established connection for wireless communication with an access point AP. On the other hand, the printing apparatus 100 is an apparatus that has not had access point information yet. In other words, the printing apparatus 100 is an apparatus that has not established connection for wireless communication with the access point AP yet. Here, the access point information is information required to establish connection for wireless communication with the access point AP. The access point information is specifically information called a configuration object in the DPP. The access point information may include, for example, at least one of a service set identifier (SSID) and a password of the access point AP. However, it is only necessary for the access point information to be information required to establish connection for wireless communication with the access point AP, and the access point information may include other information instead of the SSID or the password or in addition to the SSID or the password. Specifically, the access point AP is, for example, a wireless local area network (LAN) router.

In the present embodiment, the access point information is transmitted from the terminal apparatus 200 to the printing apparatus 100 in accordance with a procedure defined by the DPP. This enables the printing apparatus 100 to establish connection for wireless communication with the access point AP. In the present embodiment, the terminal apparatus 200 operates as a configurator defined by the DPP, and the printing apparatus 100 operates as an enrollee defined by the DPP.

The printing apparatus 100 is a printer that prints information on a medium such as paper. Note that the printing apparatus 100 may be, for example, a printer that does not include a display. In a case where the printing apparatus 100 does not include a display, a code image or the like, which will be described later, cannot be displayed. In such a case, in particular, the printing apparatus 100 needs to print the code image in order to present the code image to a user U. Although it is thus preferable that the features for solving the problems described in the present disclosure be applied to a printer which does not include a display, in particular, the features may be applied to a printer which includes a display. This is because, for example, there may be a case where it is not preferable to display the code image on the display for some reason such as the size of the display being too small, a case where it is not possible to display the code image on the display due to technical restrictions, restrictions on specifications, or the like, or a case where it is desired to avoid displaying the code image.

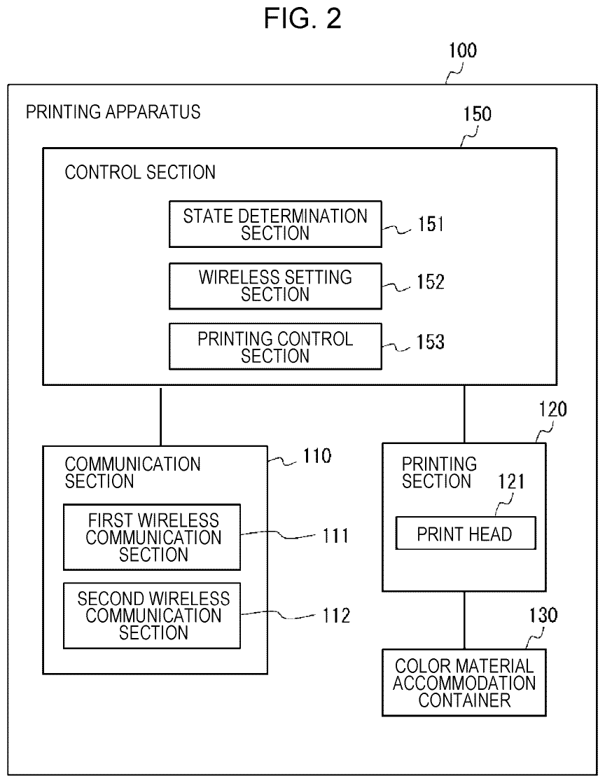

FIG. 2 is a block diagram illustrating an example of a configuration of the printing apparatus 100. As illustrated in FIG. 2, the printing apparatus 100 includes a communication section 110, a printing section 120, a color material accommodation container 130, and a control section 150.

The communication section 110 is a hardware circuit that performs wireless communication with other apparatuses in accordance with a predetermined communication standard and may include software such as firmware. The communication section 110 includes a first wireless communication section 111 and a second wireless communication section 112.

The first wireless communication section 111 is a circuit that performs communication in accordance with a first wireless communication standard. In other words, the first wireless communication section 111 transmits information in accordance with the first wireless communication standard or receives information in accordance with the first wireless communication standard. Specifically, the first wireless communication section 111 performs wireless communication in accordance with the Wi-Fi (registered trademark) standard in the present embodiment.

The second wireless communication section 112 is a circuit that performs communication in accordance with a second wireless communication standard. In other words, the second wireless communication section 112 transmits information in accordance with the second wireless communication standard or receives information in accordance with the second wireless communication standard. In the present embodiment, the second wireless communication section 112 performs Bluetooth (registered trademark) communication, which is communication in accordance with the Bluetooth standard. More specifically, the second wireless communication section 112 performs wireless communication in accordance with the Bluetooth Low Energy (BLE) standard, which is a power saving standard of Bluetooth in the present embodiment.

The printing section 120 includes a print engine which is a mechanical configuration that performs printing on a medium. Note that although a configuration of ink jet printing will be described as the configuration of the printing section 120 in the present embodiment, the printing section 120 may include a print engine configured to perform printing with a color material (toner) by an electrophotographic scheme. Although the medium is, for example, paper, the medium may be cloth or the like.

In the present embodiment, the printing section 120 includes, as the print engine, a print head 121 that ejects a color material onto the medium. The print head 121 performs ink jet printing by using the supplied color material (specifically, ink). The color material is supplied from the color material accommodation container 130 mounted on the printing apparatus 100 to the print head 121. The print engine may include, in addition to the print head 121, a medium container that accommodates a medium, a transport mechanism that transports the medium from the medium container to a position facing the print head 121, a drive mechanism that drives a carriage including the print head 121, and the like. In this case, the printing section 120 prints information such as an image on the medium by ejecting the color material from the print head 121 to the medium transported by the transport mechanism.

The color material accommodation container 130 is a container that accommodates the color material to be used by the printing section 120 for printing and is, for example, a cartridge, a tank, or a pack (an ink cartridge, an ink tank, or an ink pack). The color material in the color material accommodation container 130 is supplied to the print head 121 via a supply path extending from the color material accommodation container 130 to the inside of the print head 121. When the printing apparatus 100 is shipped, the inside of the print head 121 is not filled with the color material. Therefore, it is necessary to fill the inside of the print head 121 with the color material in order to use the printing apparatus 100. Filling the print head 121 with the color material for the first time will be referred to as initial filling. More specifically, in the initial filling, the color material is suctioned from the color material accommodation container 130, and the supply path extending from the color material accommodation container 130 to the inside of the print head 121 is filled with the color material. In the present embodiment, a printing control section 153, which will be described later, performs the initial filling at a predetermined timing (for example, a timing at which a power supply of the printing apparatus 100 is turned on for the first time, a timing at which an instruction to perform the initial filling is input from the user U, or the like). Note that the instruction from the user U is input to the printing apparatus 100 by the user U operating, for example, an operation panel (not illustrated) included in the printing apparatus 100. Once the initial filling is completed, the printing control section 153 causes a non-volatile memory to store flag data indicating that the initial filling has been completed. Note that the non-volatile memory may be implemented by a memory 902, which will be described later.

The control section 150 controls operations of the printing apparatus 100. As illustrated in FIG. 2, the control section 150 includes a state determination section 151, a wireless setting section 152, and the printing control section 153.

The printing control section 153 performs various kinds of control related to printing. For example, once the first wireless communication section 111 receives print data from any apparatus connected to the access point AP via the access point AP after the connection for wireless communication between the access point AP and the first wireless communication section 111 is established, the printing control section 153 causes the printing section 120 to execute printing based on the received print data.

The control section 150 includes the state determination section 151 and the wireless setting section 152 as functions for establishing connection for wireless communication between the access point AP outside the printing apparatus 100 and the first wireless communication section 111.

The state determination section 151 determines whether printing is executable by the printing section 120. In the present embodiment, the state determination section 151 determines whether the printing is executable by the printing section 120, based on whether the initial filling has been performed and the remaining amount of the color material in the color material accommodation container 130.

The state determination section 151 determines whether the initial filling has been performed, for example, by checking whether the flag data indicating that the initial filling has been completed is stored in the predetermined non-volatile memory. In other words, the state determination section 151 determines that the initial filling has been performed if the flag data is stored in the non-volatile memory and determines that the initial filling has not been performed yet if the flag data is not stored therein.

In addition, the state determination section 151 detects the remaining amount of the color material in the color material accommodation container 130, using a sensor provided in the printing apparatus 100 or the color material accommodation container 130, for example, and determines whether the detected remaining amount is less than a predetermined threshold value.

More specifically, in a case where the initial filling has not been performed, the state determination section 151 determines that the printing is not executable by the printing section 120 in the present embodiment. In a case where the remaining amount of the color material in the color material accommodation container 130 is less than the predetermined threshold value, the state determination section 151 determines that the printing is not executable by the printing section 120. In other words, in a case where the initial filling has already been performed and the remaining amount of the color material in the color material accommodation container 130 is equal to or greater than the predetermined threshold value, the state determination section 151 determines that the printing is executable by the printing section 120. It is possible to appropriately determine whether the printing is executable by the printing section 120 through such determination.

Note that although it is determined whether the printing is executable based on the determination results of both the execution of the initial filling and the remaining amount of the color material in the present embodiment, only one of them may be used as a condition for determining whether the printing is executable. Furthermore, the state determination section 151 may determine whether the printing is executable by combining any other conditions.

In the present embodiment, the state determination section 151 further determines whether the printing section 120 has successfully printed a code image, which will be described later. In other words, the state determination section 151 determines whether the printing section 120 has failed to print the code image. In a case where a notification of an error signal indicating a failure of printing is provided from the printing section 120 after the processing of printing the code image is started, for example, the state determination section 151 determines that the printing has failed. In a case where supply of a medium to the position where the printing is to be performed by the printing section 120 has failed, for example, the printing section 120 outputs an error signal for providing a notification of occurrence of the event. In other words, the error signal is output in a case where the supply of the medium from the medium container has failed or the like. Although the state determination section 151 determines that the printing of the code image has failed in the case as described above as an example in the present embodiment, the state determination section 151 may determine that the printing of the code image has failed in a case where occurrence of other error events has been detected. In this manner, it is possible to appropriately determine the failure of printing after the start of the printing processing in the present embodiment.

The wireless setting section 152 executes processing of performing wireless setting in the printing apparatus 100. In other words, the wireless setting section 152 executes processing for establishing connection for wireless communication between the access point AP and the first wireless communication section 111. In particular, the wireless setting section 152 establishes connection for wireless communication between the access point AP and the first wireless communication section 111 in accordance with a procedure defined by the DPP (Wi-Fi Easy Connect) in the present embodiment. For this reason, the wireless setting section 152 first acquires access point information, which is information to be used to establish connection for wireless communication between the access point AP and the first wireless communication section 111, from another apparatus (the terminal apparatus 200 in the present embodiment) having access point information.

In the DPP, the processing of acquiring the access point information includes three phases. Specifically, the processing in which the apparatus operating as an enrollee acquires the access point information (that is, a configuration object) from the apparatus operating as a configurator includes three phases, namely bootstrapping, authentication, and configuration.

The bootstrapping is processing in which the enrollee provides predetermined information to the configurator. The predetermined information is information necessary for the configurator to start communication with the enrollee in the authentication, which is the following phase, and specifically includes a bootstrapping key defined by the DPP. The bootstrapping key is a public key of the enrollee. In other words, the predetermined information is information that needs to be provided to the terminal apparatus 200 in order for the terminal apparatus 200 (configurator) to start communication with the printing apparatus 100 in accordance with a predetermined communication procedure for the first wireless communication section 111 (that is, the enrollee, which is the printing apparatus 100) to receive the access point information from the terminal apparatus 200. In yet other words, it is possible to state that the predetermined information is information that the printing apparatus 100 needs to provide to the terminal apparatus 200 in order to enable the terminal apparatus 200 to execute predetermined communication (communication in the authentication phase, which will be described later). Note that the predetermined information may include information such as a media access control (MAC) address of the printing apparatus 100. Hereinafter, the predetermined information described above will also be referred to as bootstrapping information.

As a method of providing the predetermined information in the bootstrapping, it is possible to provide the predetermined information through communication other than the first wireless communication standard (Wi-Fi standard) or to provide the predetermined information by a QR code (registered trademark). On the other hand, communication between the terminal apparatus 200 and the printing apparatus 100 in the authentication phase and the configuration phase is performed in accordance with the Wi-Fi standard. In other words, the printing apparatus 100 communicates with the terminal apparatus 200 by using the first wireless communication section 111 in the authentication phase and the configuration phase.

The authentication is processing in which the configurator (terminal apparatus 200) and the enrollee (printing apparatus 100) mutually authenticate each other and generate a shared key to be used for encryption of configuration object transmission. In other words, a key for encrypting the access point information is generated in this phase. Each of the terminal apparatus 200 and the printing apparatus 100 (wireless setting section 152) generates the shared key, based on Elliptic Curve Diffie-Hellman key exchange (ECDH), for example. In the authentication phase, the terminal apparatus 200 serving as the configurator first transmits a signal called a DPP authentication request to the printing apparatus 100 serving as the enrollee. This signal includes a message generated using the predetermined information acquired from the printing apparatus 100 in the bootstrapping phase. Therefore, it is possible to state that the predetermined information is information that needs to be provided to the terminal apparatus 200 in order for the terminal apparatus 200 to start communication (DPP authentication request) with the printing apparatus 100 in accordance with the predetermined communication procedure as described above. Note that in the authentication phase, a signal called a DPP authentication response is transmitted from the enrollee to the configurator after the transmission of the DPP authentication request. Finally, a signal called DPP authentication confirm is transmitted from the configurator to the enrollee.

The configuration is processing of transmitting the access point information (configuration object) from the configurator to the enrollee through encrypted communication using the shared key generated in the authentication phase. Specifically, the printing apparatus 100 serving as the enrollee first transmits a signal called a DPP configuration request to the terminal apparatus 200 serving as the configurator in the configuration phase. In response to this, the configurator transmits a signal called a DPP configuration response to the enrollee. The DPP configuration response includes the access point information (configuration object).

As described above, the bootstrapping needs to be performed in order for the printing apparatus 100 to acquire the access point information from the terminal apparatus 200. In other words, the bootstrapping information (predetermined information) needs to be provided from the printing apparatus 100 to the terminal apparatus 200. In recent years, code images such as QR codes have widely been used, and many users U are familiar with procedures using the code images. Therefore, it is preferable that the bootstrapping information be provided to the terminal apparatus 200 through the procedure in which the printing apparatus 100 outputs the code image including the bootstrapping information and the terminal apparatus 200 is caused to read the code image by an operation of the user U. On the other hand, the provision of the bootstrapping information through the Bluetooth communication in accordance with the BLE standard is inferior to the provision by the reading of the code image from the viewpoint of user friendliness because the user U needs to perform an unfamiliar permission operation for permitting execution of the communication on the terminal apparatus 200 in advance, for example. From such a background, it is desirable to provide the bootstrapping information by outputting the code image. In particular, in a case where it is difficult to display the code image on a display, such as a case where the printing apparatus 100 does not include a display, it is desirable to provide the bootstrapping information by printing the code image. However, if the code image cannot be printed in the case of such provision, the bootstrapping information cannot be provided, and the printing apparatus 100 cannot acquire the access point information. Therefore, the wireless setting section 152 switches the method of providing the bootstrapping information in accordance with the determination result of the state determination section 151 in the present embodiment.

The wireless setting section 152 controls printing or transmission of the predetermined information (bootstrapping information) as processing in the bootstrapping phase defined by the DPP. Specifically, in a case where the state determination section 151 determines that the printing is executable by the printing section 120, the wireless setting section 152 causes the printing section 120 to print the code image including the predetermined information (bootstrapping information). Specifically, the wireless setting section 152 generates an image of a two-dimensional code such as a QR code in which the predetermined information is encoded, and provides an instruction to execute the printing of the image to the printing control section 153. In response to this, the printing control section 153 controls the printing section 120 to start printing processing of the image. Note that this printing processing is not always successfully performed, and the state determination section 151 determines whether the printing has been successfully performed as described above.

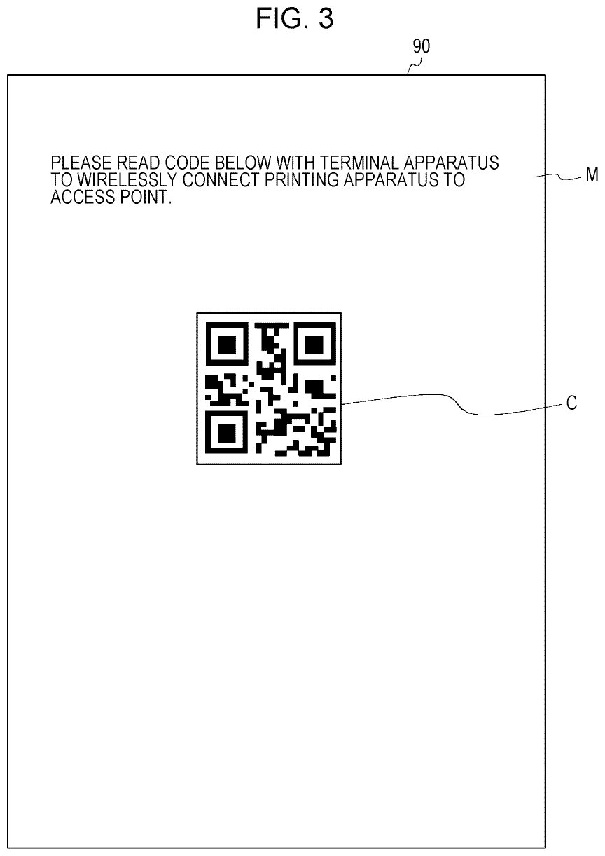

FIG. 3 is a diagram illustrating an example of printing performed by the printing section 120. As illustrated in FIG. 3, a code image C including predetermined information is printed on a medium 90. Note that as illustrated in FIG. 3, not only the code image C but also a message M for the user U may be printed. The message M is a message explaining a work to be performed by the user U and is, for example, a message prompting the user U to read the code image C with the terminal apparatus 200. Furthermore, the message M may be a message for notifying the user U of the fact that reading of the code image C is an operation necessary for connecting the printing apparatus 100 to the access point as illustrated in FIG. 3. The printing apparatus 100 becomes a more user-friendly printing apparatus by printing the message M along with the code image C.

Also, in a case where the state determination section 151 determines that the printing is not executable by the printing section 120, the wireless setting section 152 causes the second wireless communication section 112 to transmit the predetermined information (bootstrapping information). The wireless setting section 152 also causes the second wireless communication section 112 to transmit the predetermined information (bootstrapping information) in a case where the state determination section 151 determines that the printing of the code image has failed. Therefore, in these cases, the predetermined information is transmitted to the terminal apparatus 200 through the BLE communication in the present embodiment. This makes it possible to reliably perform the bootstrapping.

In this manner, the bootstrapping is performed in accordance with the determination result of the state determination section 151 in the present embodiment. Once the first wireless communication section 111 receives a signal in the authentication phase from the terminal apparatus 200 after the bootstrapping is performed, the wireless setting section 152 executes the processing in the authentication phase and the configuration phase in accordance with the procedure defined by the DPP. In this manner, the wireless setting section 152 acquires the access point information from the terminal apparatus 200. Once the access point information is acquired, the wireless setting section 152 performs processing of establishing connection for wireless communication with the access point AP by using the acquired access point information.

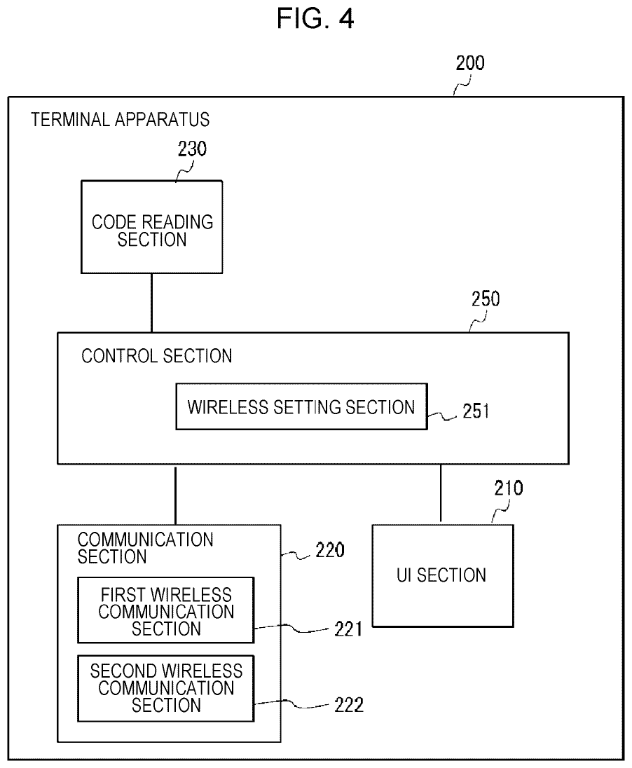

Next, the terminal apparatus 200 will be described. The terminal apparatus 200 is an apparatus operated by the user U and is, for example, a smartphone, a tablet terminal, or a personal computer. FIG. 4 is a block diagram illustrating an example of a configuration of the terminal apparatus 200. As illustrated in FIG. 4, the terminal apparatus 200 includes a UI section 210, a communication section 220, a code reading section 230, and a control section 250.

The UI section 210 is a user interface device including a display and an input device such as a button or a pointing device that receives an input operation from the user U. Note that the UI section 210 may be a touch panel in which the input device and the display are integrally configured.

The communication section 220 is a hardware circuit that performs wireless communication with other apparatuses in accordance with a predetermined communication standard and may include software such as firmware. The communication section 220 includes a first wireless communication section 221 and a second wireless communication section 222.

The first wireless communication section 221 is a circuit that performs communication in accordance with the first wireless communication standard described above. Specifically, the first wireless communication section 221 performs wireless communication in accordance with the Wi-Fi standard.

The second wireless communication section 222 is a circuit that performs communication in accordance with the second wireless communication standard described above. In the present embodiment, the second wireless communication section 222 performs Bluetooth communication, which is communication in accordance with the Bluetooth standard. More specifically, the second wireless communication section 222 performs wireless communication in accordance with the BLE standard in the present embodiment.

The code reading section 230 is a reader that reads a code image such as a QR code. The code reading section 230 may include a scanner or a camera as hardware for the reading. The code reading section 230 decodes the scanned or captured code image and reads information represented by the code image. Therefore, the code reading section 230 can read the code image of the bootstrapping information printed by the printing apparatus 100.

The control section 250 controls operations of the terminal apparatus 200. As illustrated in FIG. 4, the control section 250 includes a wireless setting section 251.

The wireless setting section 251 executes processing of assisting wireless setting in the printing apparatus 100. In particular, the wireless setting section 251 executes predetermined processing for transmitting the access point information to the printing apparatus 100. In the present embodiment, the wireless setting section 251 transmits the access point information to the printing apparatus 100 by using the first wireless communication section 221 in accordance with a procedure defined by the DPP. Specifically, the wireless setting section 251 starts the predetermined processing for transmitting the access point information to the printing apparatus 100 in response to the code reading section 230 reading the code image including the bootstrapping information or in response to the second wireless communication section 222 receiving the bootstrapping information. In other words, once the predetermined information (bootstrapping information) provided from the printing apparatus 100 is acquired, the wireless setting section 251 starts the processing in the authentication phase of the DPP. Thereafter, the wireless setting section 251 executes the processing in the configuration phase of the DPP, thereby transmitting the access point information to the printing apparatus 100.

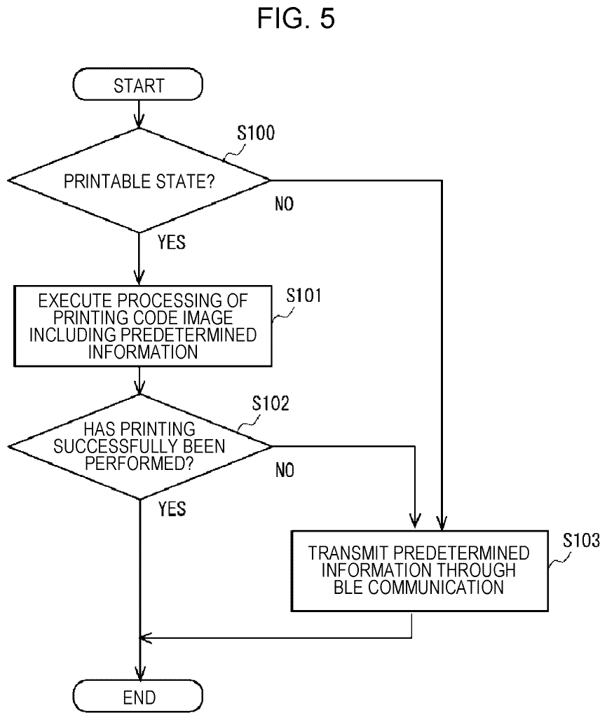

Next, a flow of the processing in the bootstrapping phase in the printing apparatus 100 will be described. FIG. 5 is a flowchart illustrating an example of the flow of the processing in the bootstrapping phase in the printing apparatus 100. Hereinafter, the flow of the processing will be described with reference to FIG. 5. The series of processing illustrated in FIG. 5 is executed in response to the power supply of the printing apparatus 100 being turned on for the first time or in response to an instruction to perform wireless connection setting being input from the user U to the printing apparatus 100. Note that the instruction from the user U is input to the printing apparatus 100 by the user U operating, for example, an operation panel (not illustrated) included in the printing apparatus 100.

In Step S100, the state determination section 151 determines whether printing is executable by the printing section 120. In a case where it is determined that printing is executable, the processing proceeds to Step S101. On the other hand, in a case where it is determined that printing is not executable, the processing proceeds to Step S103.

In Step S101, the wireless setting section 152 provides an instruction to execute printing of the code image including the predetermined information to the printing control section 153, and the printing control section 153 executes the processing of printing the code image. Thereafter, the processing proceeds to Step S102.

In Step S102, the state determination section 151 determines whether the code image has been successfully printed. In other words, the state determination section 151 determines whether the printing processing performed in Step S101 has been ended normally without any printing error being detected. In a case where the code image has been successfully printed, the processing in the bootstrapping phase ends. On the other hand, in a case where the code image has not been successfully printed, that is, in a case where the printing of the code image has failed, the processing proceeds to Step S103.

Once the processing proceeds to Step S103, the wireless setting section 152 causes the second wireless communication section 112 to transmit the predetermined information. In other words, the second wireless communication section 112 transmits the predetermined information through the BLE communication in this case. In this manner, the processing in the bootstrapping phase ends.

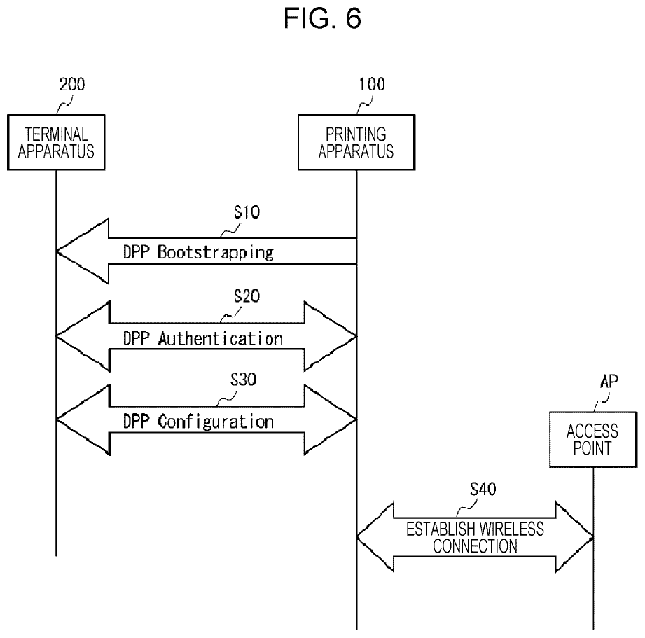

Next, a flow of operations by which the printing apparatus 100 establishes wireless connection with the access point AP will be described. FIG. 6 is a sequence chart illustrating an example of the flow of the operations by which the printing apparatus 100 establishes wireless connection with the access point AP. Hereinafter, the flow of the operations will be described with reference to FIG. 6.

In Step S10, the processing in the bootstrapping phase of the DPP is performed, and the predetermined information is provided from the printing apparatus 100 to the terminal apparatus 200, as described above.

Next, in Step S20, the processing in the authentication phase of the DPP is performed between the terminal apparatus 200 and the printing apparatus 100. Thus, a key for transmitting the access point information through encrypted communication is generated.

Next, in Step S30, the processing in the configuration phase of the DPP is performed between the terminal apparatus 200 and the printing apparatus 100. As a result, the access point information is transmitted from the terminal apparatus 200 to the printing apparatus 100.

Thereafter, in Step S40, the printing apparatus 100 establishes wireless connection (connection for wireless communication in accordance with the Wi-Fi standard) with the access point AP by using the access point information. In other words, in Step S40, the printing apparatus 100 participates in a LAN using the access point AP by using the access point information.

In this manner, the predetermined information (bootstrapping information) is provided by the method in accordance with the determination result of the state determination section 151 in the present embodiment. For this reason, it is possible to realize the provision by a method that is preferable from the viewpoint of user friendliness (printing of a code image) as much as possible and to also avoid occurrence of a situation in which setting of wireless connection becomes impossible in a case where it is not possible to provide the predetermined information by the method.

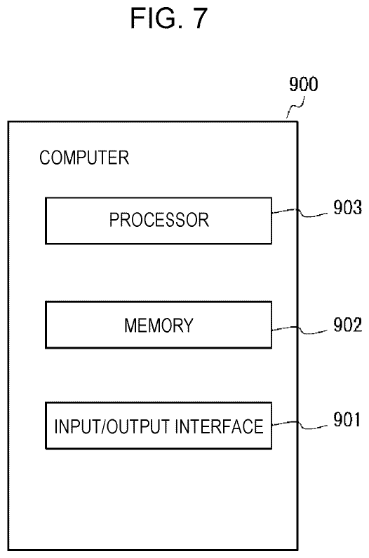

Although the embodiment has been described above, the processing of the printing apparatus 100 and the terminal apparatus 200 may be executed by a computer included in each apparatus. Note that the computer may be configured as a System on a Chip (SoC). FIG. 7 is a block diagram illustrating an example of a hardware configuration of a computer 900 included in the printing apparatus 100 or the terminal apparatus 200. As illustrated in FIG. 7, the computer 900 includes, for example, an input/output interface 901, the memory 902, and a processor 903.

The input/output interface 901 is used to communicate with any circuit or apparatus.

The memory 902 is configured by, for example, a combination of a volatile memory and a non-volatile memory. The memory 902 is used to store a program to be executed by the processor 903, data to be used for various kinds of processing, and the like.

The processor 903 performs various kinds of processing described in the above-described embodiment by reading the program from the memory 902 and executing the program. The processor 903 may be, for example, a microprocessor, a micro processor unit (MPU), or a central processing unit (CPU). Furthermore, the processor 903 may include a plurality of processors.

The program includes a group of commands (or software codes) for causing the computer to perform one or more of the functions described in the embodiment in a case where the program is read by the computer. The program may be stored in a non-transitory computer-readable medium or a tangible storage medium. By way of a non-limiting example, such a computer-readable medium or a tangible storage medium includes a random-access memory (RAM), a read-only memory (ROM), a flash memory, a solid-state drive (SSD), and other memory techniques, a CD-ROM, a digital versatile disc (DVD), a Blu-ray (registered trademark) disc, and other optical disc storages, a magnetic cassette, a magnetic tape, a magnetic disk storage, and other magnetic storage devices. The program may be transmitted on a transitory computer-readable medium or a communication medium. By way of a non-limiting example, the transitory computer-readable medium or the communication medium includes a propagating signal in an electrical, optical, acoustic, or other forms.

Note that the present disclosure is not limited to the above embodiment and can be appropriately modified within the scope without departing from the gist thereof. For example, although the predetermined information is transmitted through the Bluetooth communication in the case where it is determined that the printing is not executable by the printing section 120 and in the case where the printing of the code image has failed in the above-described embodiment, the predetermined information may be transmitted through near field communication (NFC). In this case, the second wireless communication section 112 of the printing apparatus 100 performs communication in accordance with the NFC standard as the communication of the second wireless communication standard. Although the method of providing the predetermined information is selected depending on whether the printing is executable by the printing section 120 in the above-described embodiment, the wireless setting section 152 may select a providing method as follows. It is apparent that the initial filling has not been executed and printing cannot be performed at the timing at which the power supply of the printing apparatus 100 is turned on for the first time. Therefore, the wireless setting section 152 may cause the second wireless communication section 112 to transmit the predetermined information in response to the power supply of the printing apparatus 100 being turned on for the first time, and the printing apparatus 100 may start the series of processing illustrated in FIG. 5 described above in response to an instruction to perform wireless connection setting being input from the user U to the printing apparatus 100, for example. In this case, the state determination section 151 may determine whether the power supply of the printing apparatus 100 has been turned on for the first time by checking whether flag data that is stored in a non-volatile memory by the power supply being turned on for the first time and that indicates the execution of the first turning-on of the power supply is stored in the non-volatile memory, for example.

A part or an entirety of the embodiment described above may be described as, but not limited to, the following appendixes.

### Appendix 1

A printing apparatus including: a printing section configured to perform printing on a medium; a first wireless communication section configured to perform communication in accordance with a first wireless communication standard; a second wireless communication section configured to perform communication in accordance with a second wireless communication standard; a state determination section configured to determine whether printing is executable by the printing section; and a wireless setting section configured to cause the printing section to print a code image including predetermined information in a case where it is determined that the printing is executable by the printing section and cause the second wireless communication section to transmit the predetermined information in a case where it is determined that the printing is not executable by the printing section, in which the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

### Appendix 2

The printing apparatus according to Appendix 1, in which the printing section includes a print head configured to eject a color material onto the medium, and the state determination section determines that the printing is not executable by the printing section in a case where initial filling of filling the print head with the color material for a first time has not been performed.

### Appendix 3

The printing apparatus according to Appendix 1 or 2, in which the state determination section determines that the printing is not executable by the printing section in a case where a remaining amount of a color material, which is to be used for the printing by the printing section, in a color material accommodation container configured to accommodate the color material is less than a predetermined threshold value.

### Appendix 4

The printing apparatus according to any one of Appendixes 1 to 3, in which the state determination section further determines whether the printing section has successfully printed the code image, and the wireless setting section causes the second wireless communication section to transmit the predetermined information in a case where it is determined that the printing of the code image has failed.

### Appendix 5

The printing apparatus according to Appendix 4, in which the state determination section determines that the printing of the code image has failed in a case where supply of the medium to a position where the printing section is to perform the printing has failed.

### Appendix 6

The printing apparatus according to any one of Appendixes 1 to 5, in which the printing apparatus operates as an enrollee defined by a Device Provisioning Protocol (DPP), and the wireless setting section controls printing or transmission of the predetermined information as processing in a bootstrapping phase defined by the DPP.

### Appendix 7

The printing apparatus according to any one of Appendixes 1 to 6, in which the communication in accordance with the second wireless communication standard is Bluetooth communication or near field communication (NFC).

### Appendix 8

A processing method of causing a printing apparatus that includes a printing section configured to perform printing on a medium, a first wireless communication section configured to perform communication in accordance with a first wireless communication standard, and a second wireless communication section configured to perform communication in accordance with a second wireless communication standard to: determine whether printing is executable by the printing section; cause the printing section to print a code image including predetermined information in a case where it is determined that the printing is executable by the printing section; and cause the second wireless communication section to transmit the predetermined information in a case where it is determined that the printing is not executable by the printing section, in which the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

### Appendix 9

A non-transitory computer-readable storage medium storing a program that causes a computer of a printing apparatus that includes a printing section configured to perform printing on a medium, a first wireless communication section configured to perform communication in accordance with a first wireless communication standard, and a second wireless communication section configured to perform communication in accordance with a second wireless communication standard to: determine whether printing is executable by the printing section; and cause the printing section to print a code image including predetermined information in a case where it is determined that the printing is executable by the printing section and cause the second wireless communication section to transmit the predetermined information in a case where it is determined that the printing is not executable by the printing section, in which the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

What is claimed is:

1. A printing apparatus comprising:
a printing section configured to perform printing on a medium;
a first wireless communication section configured to perform communication in accordance with a first wireless communication standard;
a second wireless communication section configured to perform communication in accordance with a second wireless communication standard;
a state determination section configured to determine whether printing is executable by the printing section; and
a wireless setting section configured to cause the printing section to print a code image including predetermined information in a case where it is determined that the printing is executable by the printing section and cause the second wireless communication section to transmit the predetermined information in a case where it is determined that the printing is not executable by the printing section,
wherein the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

2. The printing apparatus according to claim 1,
wherein the printing section includes a print head configured to eject a color material onto the medium, and
the state determination section determines that the printing is not executable by the printing section in a case where initial filling of filling the print head with the color material for a first time has not been performed.

3. The printing apparatus according to claim 1, wherein the state determination section determines that the printing is not executable by the printing section in a case where a remaining amount of a color material, which is to be used for the printing by the printing section, in a color material accommodation container configured to accommodate the color material is less than a predetermined threshold value.

4. The printing apparatus according to claim 1,
wherein the state determination section further determines whether the printing section has successfully printed the code image, and
the wireless setting section causes the second wireless communication section to transmit the predetermined information in a case where it is determined that the printing of the code image has failed.

5. The printing apparatus according to claim 4, wherein the state determination section determines that the printing of the code image has failed in a case where supply of the medium to a position where the printing section is to perform the printing has failed.

6. The printing apparatus according to claim 1,
wherein the printing apparatus operates as an enrollee defined by a Device Provisioning Protocol (DPP), and
the wireless setting section controls printing or transmission of the predetermined information as processing in a bootstrapping phase defined by the DPP.

7. The printing apparatus according to claim 1, wherein the communication in accordance with the second wireless communication standard is Bluetooth communication or near field communication (NFC).

8. A processing method of causing a printing apparatus that includes a printing section configured to perform printing on a medium, a first wireless communication section configured to perform communication in accordance with a first wireless communication standard, and a second wireless communication section configured to perform communication in accordance with a second wireless communication standard to:
determine whether printing is executable by the printing section;
cause the printing section to print a code image including predetermined information in a case where it is determined that the printing is executable by the printing section; and
cause the second wireless communication section to transmit the predetermined information in a case where it is determined that the printing is not executable by the printing section,
wherein the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.

9. A non-transitory computer-readable storage medium storing a program that causes a computer of a printing apparatus that includes a printing section configured to perform printing on a medium, a first wireless communication section configured to perform communication in accordance with a first wireless communication standard, and a second wireless communication section configured to perform communication in accordance with a second wireless communication standard to:
determine whether printing is executable by the printing section; and
cause the printing section to print a code image including predetermined information in a case where it is determined that the printing is executable by the printing section and cause the second wireless communication section to transmit the predetermined information in a case where it is determined that the printing is not executable by the printing section,
wherein the predetermined information is information that needs to be provided to a terminal apparatus in order for the terminal apparatus to start communication in accordance with a predetermined communication procedure for the first wireless communication section to receive, from the terminal apparatus, access point information that is information to be used to establish connection for wireless communication between an access point and the first wireless communication section.
